(19) United States
(12) Patent Application Publication
(10) Pub. No.: US 2014/0244538 A1
(43) Pub. Date: Aug. 28, 2014

(54) BUSINESS PROCESS MANAGEMENT, CONFIGURATION AND EXECUTION

(71) Applicant: INTERNATIONAL BUSINESS MACHINES CORPORATION, Armonk, NY (US)

(72) Inventors: Duane A. Harmon, Kansas City, MO (US); Richard J. Kezys, Smithtown, NY (US); Bertrand H. Portier, Austin, TX (US); Michael G. Steele, North Lawrence, OH (US)

(73) Assignee: INTERNATIONAL BUSINESS MACHINES CORPORATION, Armonk, NY (US)

(21) Appl. No.: 13/781,547

(22) Filed: Feb. 28, 2013

(51) Int. Cl. G06Q 10/06

(52) U.S. Cl. CPC G06Q 10/067
USPC 705/348

(57) ABSTRACT

Methods and systems may provide for identifying a first process template associated with a first business process, and modifying an arrangement of the first process template based on user input to obtain a second process template. The second process template may be associated with a second business process. In one example, a validation of the second process template is conducted.

### BACKGROUND

Embodiments of the present invention generally relate to business process management. More particularly, embodiments relate to the modification and validation of business process templates.

Conventional approaches to business process management (BPM) may involve modeling a business process as a set of encapsulated service invocations. Once a given business process model is deployed, exceptions can arise that were not known or expected at the time of model development. Taking those exceptions into account may involve re-modeling the business process, additional configurations, additional coding, and additional testing, which can be costly and time consuming, particularly in situations where different exceptions are encountered frequently. While certain solutions may attempt to facilitate modification of business process models, there remains considerable room for improvement.

For example, changes to business process models may require technical skills that certain individuals (e.g., subject matter experts) may not have at the time of configuration and/or deployment. Indeed, the necessary combination of development skills, process skills, configuration skills and subject matter expertise may generally not be found in any one individual, therefore leading to the involvement of multiple participants and a significant amount of time to deliver even the simplest change. Moreover, conventional BPM solutions may have relatively complex interfaces that are inappropriate for modern computing scenarios such as mobile environments.

### BRIEF SUMMARY

Embodiments may include a method in which a first process template associated with a first business process is identified. The method may also provide for modifying an arrangement of the first process template based on user input to obtain a second process template, wherein the second process template is associated with a second business process.

Embodiments may include a computer program product having a computer readable storage medium and computer usable code stored on the computer readable storage medium. If executed by a processor, the computer usable code may cause a computer to identify a first process template associated with a first business process, and modify an arrangement of the first process template based on user input to obtain a second process template. The second process template may be associated with a second business process.

Embodiments may include a computer program product having a computer readable storage medium and computer usable code stored on the computer readable storage medium. If executed by a processor, the computer usable code may cause a computer to identify a first process template associated with a first business process, and modify an arrangement of the first process template based on user input to obtain a second process template. The second process template may be associated with a second business process, wherein the first process template and the second process template are to include a plurality of business fragments. The arrangement may include one or more of an order and a composition of the plurality of business fragments. Additionally, a validation of the second process template may be conducted against one or more sequencing heuristics, wherein the second process template may be deployed to an execution system if the validation is successful.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a business process management solution according to an embodiment;

FIG. 2 is an illustration of an example of a user interface according to an embodiment;

FIG. 3 is a block diagram of an example of a business fragment having a composite service according to an embodiment;

FIG. 4 is a flowchart of an example of a method of managing business processes according to an embodiment; and

FIG. 5 is a block diagram of an example of a computing device according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

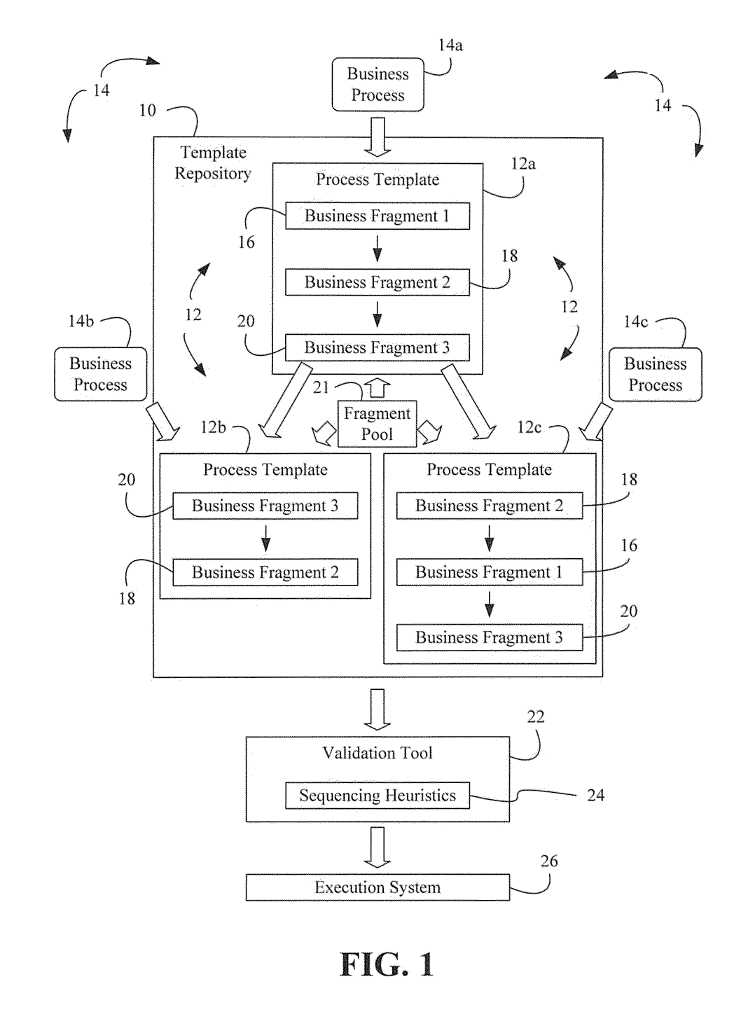

Referring now to FIG. 1, a business process management (BPM) solution is shown in which a template repository 10 stores a plurality of process templates 12 (12a-12c), wherein the process templates 12 are associated with a corresponding plurality of business processes 14 (14a-14c). In the illustrated example, a first process template 12a includes a set of business fragments 16, 18, 20 arranged in a particular order in accordance with a first business process 14a. As will be discussed in greater detail, a second process template 12b may be derived from the first process template 12b, wherein the second process template 12b represents a modification of the arrangement of the first process template 12a in accordance with a second business process 14b. For example, the second process template 12b might include the business fragments 18, 20 arranged in a different order than the arrangement of the first process template 12a. Thus, the second process template 12b may address a particular exception to the first business process 14a that eliminates any need for the business fragment 16 and calls for the execution of the business fragment 20 before execution of the business fragment 18.

Similarly, a third process template 12c may be derived from the first process template 12b, wherein the third process template 12c represents another modification of the arrangement of the first process template 12a in accordance with a third business process 14c. For example, the third process template 12c might include the business fragments 16, 18, 20 arranged in a different order than the arrangement of the first process template 12a. Thus, the third process template 12c may address another exception to the first business process 14a that calls for the execution of the business fragment 18 before execution of the business fragment 16. The process templates 12 may be industry specific (e.g., digital content distribution, educational, finance, human resources, etc.) in order to facilitate easy modification between templates and reuse of business fragments. Additionally, each business fragment may include a composite service as appropriate. For example, the business fragment 16 may involve the invocation of services from two entirely different entities. As a result, the business fragments may be defined at a relatively high level that can be more easily understood by individuals likely to be tasked with template modification.

In addition, one or more additional business fragments from a pool of fragments 21 may be incorporated into the second process template 12b and/or the third process template 12c based on the user input. Thus, additional process templates may be the derivative of a previous process template, various business fragments that is greater than the pool of business fragments in a given template, or any combination thereof.

The illustrated solution also includes a validation tool 22 that validates the process templates 12 against one or more sequencing heuristics 24. For example, the validation tool 22 may be used to perform a check as to whether the order of the business fragments 18, 20 in the second process template 12b comply with commonly understood process sequencing in the industry in question (e.g., manufacturing before distribution). If the validation is successful, the process templates 12 may be deployed to an execution system 26 such as, for example, BPM Process Server from IBM Corporation, BPM Suite from Oracle, etc. The execution system 26 may provide deterministic execution of the process templates 12 in the sequence that is predetermined and specified at the time of creation of the templates 12.

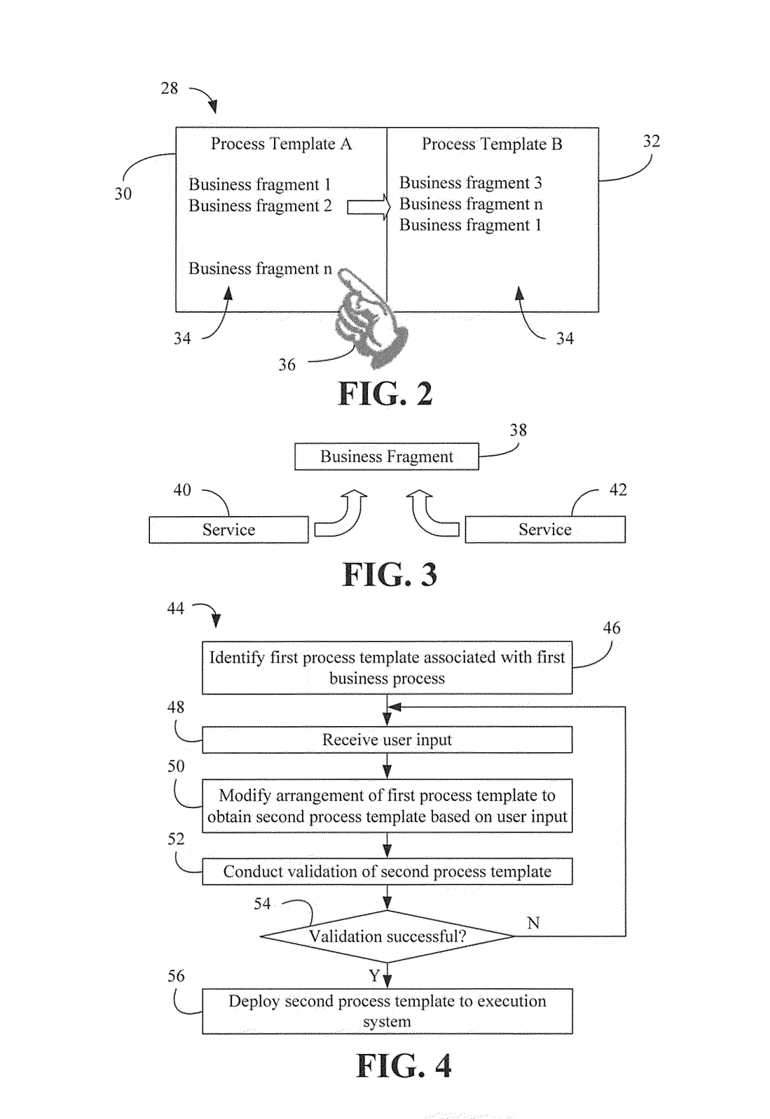

FIG. 2 shows a user interface 28 that enables the creation of a second process template (“Process Template B”) 32 from a first process template (“Process Template A”) 30. The user interface 28 may be implemented in a computing scenario such as in a touch screen of a mobile device (e.g., wireless phone, smart tablet), wherein one or more business fragments 34 may be dragged and dropped from the first process template 30 into the second process template 32 in the desired order via a simple motion of a hand 36 and/or finger. Thus, the illustrated user interface 28 eliminates any need to type complex configuration information/metadata and facilitates deployment of the BPM tool in fast-paced, mobile environments.

FIG. 3 shows a business fragment 38 that is made up of multiple services 40, 42 that form a “composite” service. The services 40, 42 may be performed and/or conducted by different entities crossing a wide variety of geographic, organizational, contractual and/or governmental boundaries. As already noted, such an approach enables process templates to be defined at a relatively high level that can be more easily understood by individuals likely to be tasked with template modification.

Turning now to FIG. 4, a method 44 of managing business processes is shown. Illustrated processing block 46 provides for identifying a first process template associated with a first business process, wherein identifying the first process template may involve selecting the first process template from a plurality of industry specific process templates. User input may be received at block 48. In one example, the user input is received via a mobile device user interface such as, for example, the user interface 28 (FIG. 2), already discussed. An arrangement of the first process template may be modified at block 50 based on the user input to obtain a second process template. Illustrated block 52 conducts a validation of the second process template, wherein the validation may apply one or more sequencing heuristics to the second process template. If it is determined at block 54 that the validation is successful, the second process template may be deployed to an execution system at block 56. Otherwise, the process may repeat and obtain additional user input at block 48.

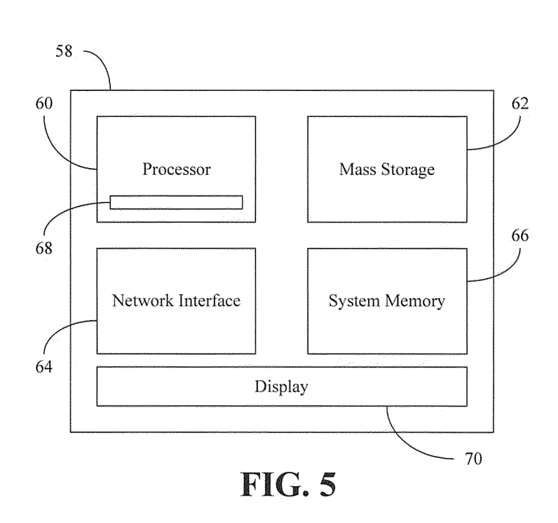

FIG. 5 shows a computing device 58 having a processor 60, mass storage 62 (e.g., read only memory/ROM, optical disk, flash memory), a network interface 64, a display 70, and system memory 66 (e.g., random access memory/RAM). In the illustrated example, the processor 60 is configured to execute logic 68, wherein the logic 68 may implement one or more aspects of the method 44 (FIG. 4), already discussed. Thus, the logic 68 may enable the computing device 58 to function as a BPM system. Additionally, the display 70 may include touch screen technology that supports the implementation of a user interface such as the user interface 28 (FIG. 2) in a fast-paced, mobile setting. Thus, the computing device 58 may be a mobile device such as a wireless phone or smart tablet. The logic 68 may also be implemented as a software application that is distributed among many computers (e.g., local or remote).

Techniques described herein may therefore enable an individual who is responsible for a process to create the metadata that defines what the process variations may be, while an individual who is a consumer of the business process may re-configure the process without repeating the process development life cycle. Additionally, techniques may enable agile, easy and rapid user-driven process configuration, rapid-to-immediate business process deployment, and valid and reasonable process activity sequencing. For example, techniques described herein may provide the ability to facilitate agile business process changes by one SME (subject matter expert, e.g., business user/end user). In addition, activities such as re-modeling, additional configurations, additional coding and additional testing may be avoided through the use of pre-determined business fragments, and process templates combined with final validation. Moreover, these techniques may be combined with a simple drag and drop selection scheme (user interface) that creates the potential for quick and easy process creation and/or modification by a business user who is expert in their domain (e.g., Auto Insurance Claims) but has little to no formal BPM background.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A computer program product comprising:
a computer readable storage medium; and
computer usable code stored on the computer readable storage medium, where, if executed by a processor, the computer usable code causes a computer to:
identify a first process template associated with a first business process;
modify an arrangement of the first process template based on user input to obtain a second process template, wherein the second process template is to be associated with a second business process, wherein the first process template and the second process template are to include a plurality of business fragments, and wherein the arrangement is to include one or more of an order and a composition of the plurality of business fragments;
conduct a validation of the second process template against one or more sequencing heuristics; and
deploy the second process template to an execution system if the validation is successful.

2. The computer program product of claim 1, wherein the computer usable code, if executed, causes a computer to incorporate one or more additional business fragments from a pool of fragments into the second process template based on the user input.

3. The computer program product of claim 1, wherein one or more of the plurality of business fragments is to include a composite service.

4. The computer program product of claim 1, wherein the computer usable code, if executed, causes a computer to select the first process template from a plurality of industry specific process templates.

5. The computer program product of claim 1, wherein the computer usable code, if executed, causes a computer to receive the user input via a user interface of a mobile device.

6-14. (canceled)

15. A computer program product comprising:
a computer readable storage medium; and
computer usable code stored on the computer readable storage medium, where, if executed by a processor, the computer usable code causes a computer to:
identify a first process template associated with a first business process; and
modify an arrangement of the first process template based on user input to obtain a second process template, wherein the second process template is to be associated with a second business process.

16. The computer program product of claim 15, wherein the computer usable code, if executed, causes a computer to conduct a validation of the second process template.

17. The computer program product of claim 16, wherein the second process template is to be validated against one or more sequencing heuristics.

18. The computer program product of claim 16, wherein the computer usable code, if executed, causes a computer to deploy the second process template to an execution system if the validation is successful.

19. The computer program product of claim 15, wherein the arrangement is to include one or more of an order and a composition of a plurality of business fragments.

20. The computer program product of claim 19, wherein the computer usable code, if executed, causes a computer to incorporate one or more additional business fragments from a pool of fragments into the second process template based on the user input.

21. The computer program product of claim 15, wherein the first process template and the second process template are to include a plurality of business fragments, and wherein one or more of the plurality of business fragments includes a composite service.

22. The computer program product of claim 15, wherein the computer usable code, if executed, causes a computer to select the first process template from a plurality of industry specific process templates.

23. The computer program product of claim 15, wherein the computer usable code, if executed, causes a computer to receive the user input via a user interface of a mobile device.
